(19) United States
(12) Patent Application Publication
(10) Pub. No.: US 2019/0203380 A1
(43) Pub. Date: Jul. 4, 2019

(54) METHOD FOR MANUFACTURING A SOLID ADSORBENT FIBER

(71) Applicant: L'Air Liquide, Societe Anonyme pour l'Etude et I'Exploitation des Procedes Georges Claude, Paris (FR)

(72) Inventors: Philippe A. COIGNET, Wilmington, DE (US); Dean W. KRATZER, Warwick, MD (US)

(73) Assignee: L'Air Liquide, Societe Anonyme pour l'Etude et I'Exploitation des Procedes Georges Claude, Paris (FR)

(21) Appl. No.: 16/230,298

(22) Filed: Dec. 21, 2018

Related U.S. Application Data
(60) Provisional application No. 62/612,517, filed on Dec. 31, 2017.

(51) Int. Cl. D01D 5/34

(52) U.S. Cl. CPC D01D 5/34; B01D 53/02

(57) ABSTRACT

A solid adsorbent fiber includes a solid support fiber is enveloped by a solidified polymeric binder and also adsorbent particles.

### CROSS-REFERENCE TO RELATED APPLICATIONS

This application claims the benefit of priority under 35 U.S.C. § 119 (e) to U.S. Provisional Patent Application No. 62/612,517 filed on Dec. 31, 2017, the entire contents of which are incorporated herein by reference.

### BACKGROUND

### Field of the Invention

The present invention relates to structured adsorbents and fluid separations utilizing the same.

### Related Art

Adsorbents are typically shaped as small beads (1-5 mm in diameter) and find widespread use in countless applications, from desiccants for insulated windows to hydrogen purification. Current adsorbent systems, however, include a number of drawbacks.

The packing density of a traditional beaded adsorbent bed is limited by the generally spherical shape of the beads. Specifically, the maximum packing density achievable with perfect spheres of identical diameter is 74%. In reality, within a bed of adsorbent beads a distribution of diameters exists. For example, a ratio of the largest diameter to the smallest diameter is may be around 2:1. Also, beads are not necessarily perfectly spherical, so that often, an average packing density of only as much as 65% is achieved.

Because current beaded adsorbent typically use brittle, clay-based binders, such as bentonite, they are intolerant to friction or impacts and consequently are prone to dusting. Given that current beaded adsorbents are typically intolerant to friction and impacts, it is standard practice to limit the gas velocity seen by the average bead to anywhere between 80 and 90% of the fluidization velocity so that fluidization and dusting are avoided. Because the gas velocity is limited, the flow rates of gas during production and depressurization steps are similarly limited. If the flow rates are limited, the speed at which an adsorbent bed can be depressurized and repressurized is also limited. This is especially true for large PSA systems. Therefore, the throughput of conventional beaded adsorbent beds is limited.

The attrition velocity is an indicator of the maximum gas velocity that the beads of conventional adsorbent beds can be subjected to without exhibiting attrition (i.e., dusting) due to friction and impacts. The attrition velocity is directly linked to the average bead-mass. As the bead mass increases, the attrition velocity increases. Therefore, one way to increase the throughput of a beaded adsorbent bed is to increase the mass of the average bead, or to put it another way, to increase the average diameter of the beads. However, increasing the mass or average diameter of the beads comes at the expense of slower kinetics due to diffusion limitations of gas transport within the beads. This is because, as the mass/diameter of a bead increases, the average path length traveled by a plug of gas from the surface of a bead to an available adsorption site within the bead will also increase.

In order to mitigate some of the above-described drawbacks, some have proposed the use of structured adsorbent beds. As opposed to the discrete structure of a beaded bed, the concept of structured adsorbent bed is to form a rigid and/or fixed adsorbent bed or continuous adsorbent structure so as to eliminate the issues related to fluidization. By doing so, the kinetics can be improved by decreasing the characteristic dimension of the adsorbent structure. As an example, a supported adsorbent layer only 0.1 mm thick can have better kinetics than a similar mass of adsorbent configured as 2 mm beads.

One type of proposed structured adsorbent beds is formed by extruding solid fibers made of adsorbent particles in a polymer matrix. However, as one loads greater and greater amounts of the adsorbent particles in the fiber, discontinuities of the continuous fiber are prevalent during extrusion given the relatively lower amounts of polymer binder present in such fibers. As a result, commercial production of such fibers may limit the amount of adsorbent particle loading in the fiber.

Therefore, there is a need for way to manufacture solid adsorbent fibers on a commercial scale that have higher adsorbent particle loading without suffering from the above-described problem.

### SUMMARY

There is disclosed a method of manufacturing supported solid adsorbent fibers, comprising the steps of: providing a spinneret that includes an aperture and an annulus surrounding at least a portion of the aperture at a downstream face of the spinneret, said aperture extending through the spinneret and being adapted and configured to receive a solid fiber support and pass the received solid fiber support from the aperture at said downstream face; simultaneously feeding the solid fiber support through the aperture and feeding the polymeric dope suspension to the aperture; simultaneously passing the solid fiber support through the aperture while extruding a polymeric dope suspension from the annulus so as to completely envelope the solid fiber, the polymeric dope suspension comprising adsorbent particles and a polymeric binder dissolved in a solvent; and coagulating the polymeric dope suspension of the polymeric dope suspension-enveloped solid fiber support in a coagulation bath wherein amounts of the solvent are removed from the extruded polymeric dope suspension and the dissolved polymeric binder enveloping the solid support fiber is solidified so as to provide supported solid adsorbent fibers.

There is also disclosed a method of manufacturing supported solid adsorbent fibers, comprising the steps of: providing a spinneret that includes an aperture and a first annulus surrounding at least a portion of the aperture at a downstream face of the spinneret; simultaneously feeding the aperture with a first polymeric dope and the first annulus with a second polymeric dope, the first polymeric dope comprising a first polymeric binder dissolved in a first solvent, the second polymeric dope comprising adsorbent particles and a second polymeric binder dissolved in a second solvent; simultaneously extruding the first polymeric dope through the aperture and extruding the second polymeric dope suspension from the first annulus so as to completely envelope the extruded first polymeric dope with the extruded second polymeric dope and form a nascent solid supported fiber; and coagulating the first and second polymeric dopes in a coagulation bath wherein amounts of the first and second solvents are removed from the extruded first and second polymeric dopes and the first and second polymeric binders are solidified so as to provide the supported solid adsorbent fibers.

Either of the above-disclosed methods may include one or more of the following aspects:

the polymeric dope suspension is degassed prior to said extrusion.

amounts of solvent remaining in the supported solid adsorbent fibers still present after said coagulation are removed.

the solid fiber support is produced by wet spinning or dry spinning;

the solid fiber support is coated with a functional layer either prior to or during said extrusion, the functional layer comprising a selective layer or protective layer.

the particles of adsorbent are a zeolite, that optionally undergoes ionic exchange in the polymeric dope suspension.

the solid fiber support is coated with an adhesion promoter layer, wherein the solid fiber support is comprised of a metal.

a surface of the solid fiber support is functionalized by one of plasma treatment and chemical exposure so as to roughen a surface of the solid fiber support.

the solid adsorbent fiber is heated to a temperature at or above an activation temperature of thee particulate adsorbent.

the solid adsorbent fiber is exposed to a cross-linker agent prior to the activation step.

the polymer binder comprises a polymer having a glass transition temperature and the solid adsorbent fiber is heated to a temperature below the glass transition temperature.

the polymer binder comprises a polymer having a glass transition temperature and the solid adsorbent fiber is heated to a temperature at or above the glass transition temperature.

a third polymeric dope is extruded from a second annulus concentrically disposed in between the aperture and the first aperture, wherein the third polymeric dope comprises a third polymeric binder dissolved in a third solvent and said coagulation step also removes amounts of said third solvent so as to solidify said third polymeric binder and form a functional layer in between the first solidified polymeric binder and the second solidified polymeric binder, the functional layer being a selective layer or a protective layer.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a schematic of one embodiment of the inventive method.

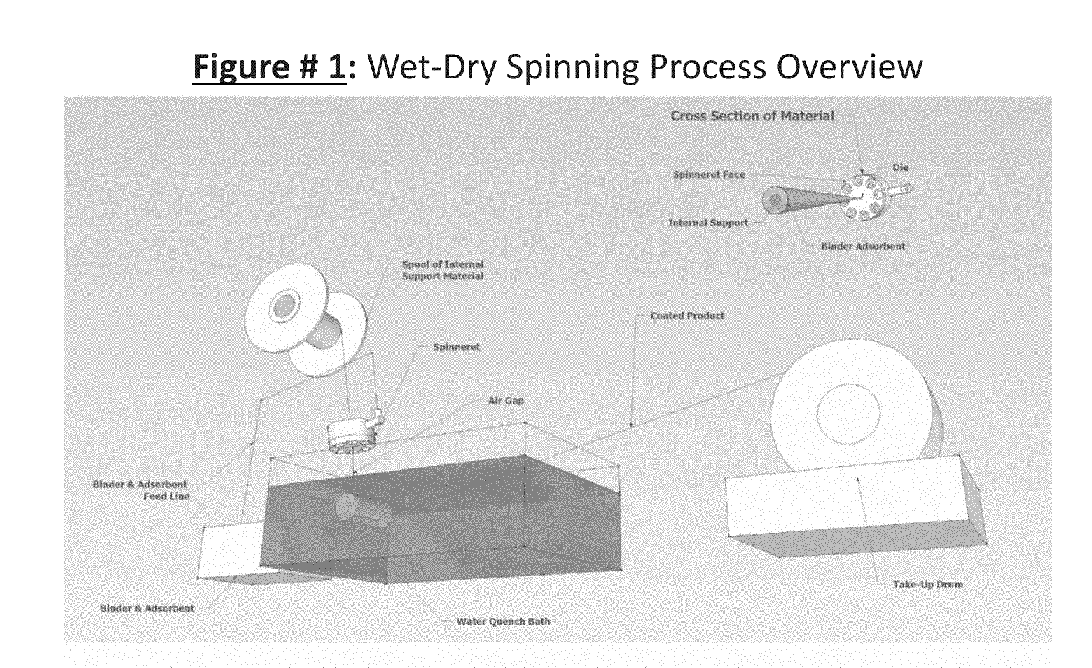

FIG. 2 is a photograph of an upstream face of the spinneret.

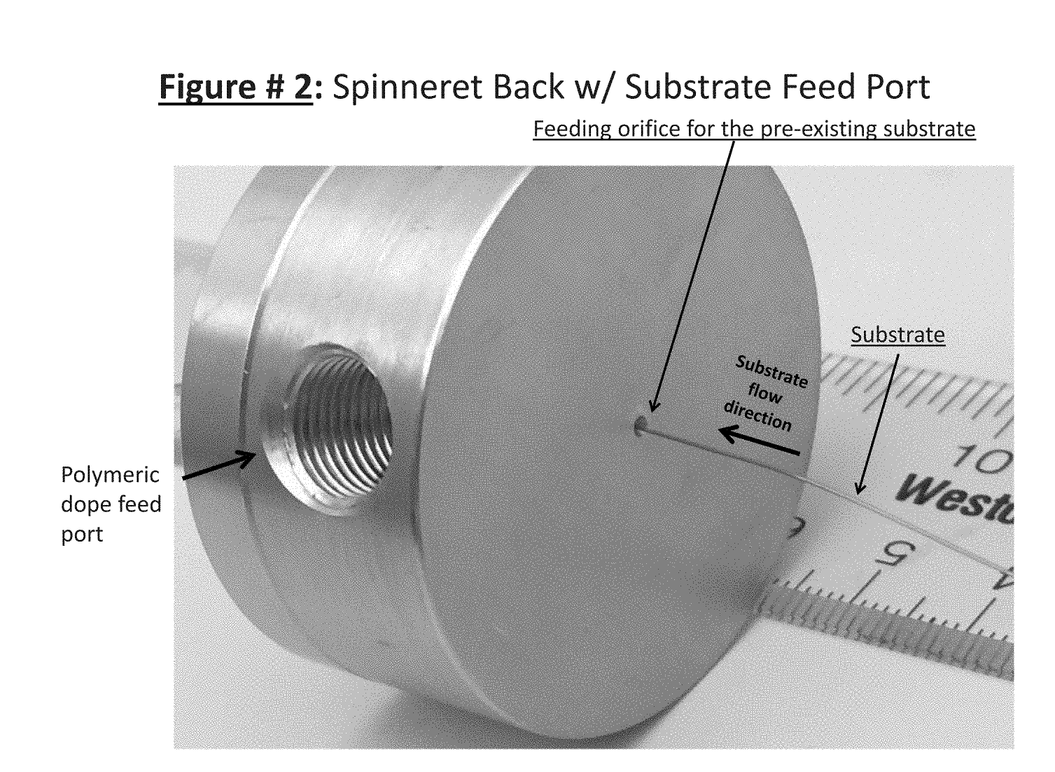

FIG. 3 is a photograph of the spinneret unassembled.

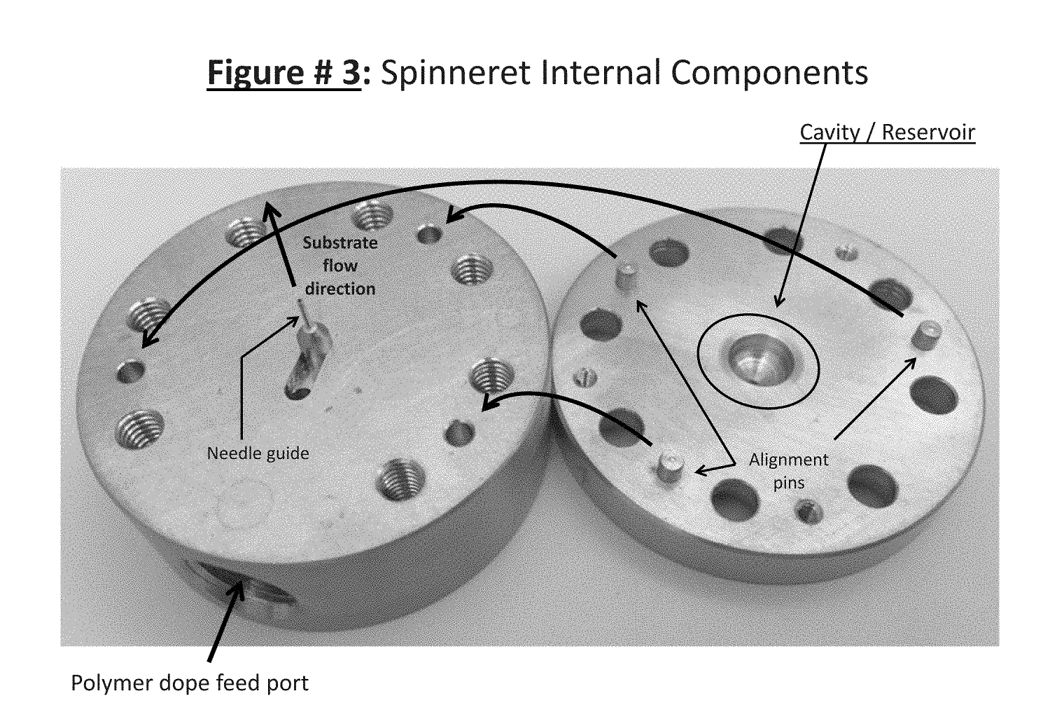

FIG. 4 is a photograph of a downstream face of the spinneret.

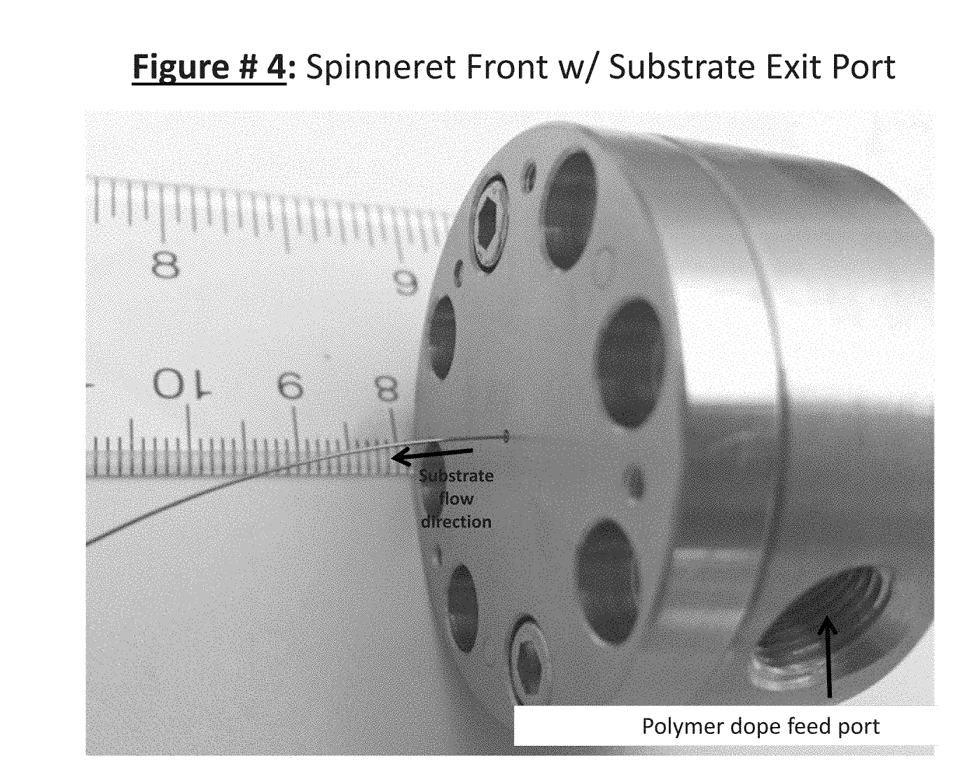

FIG. 5 is another photograph of a downstream face of the spinneret.

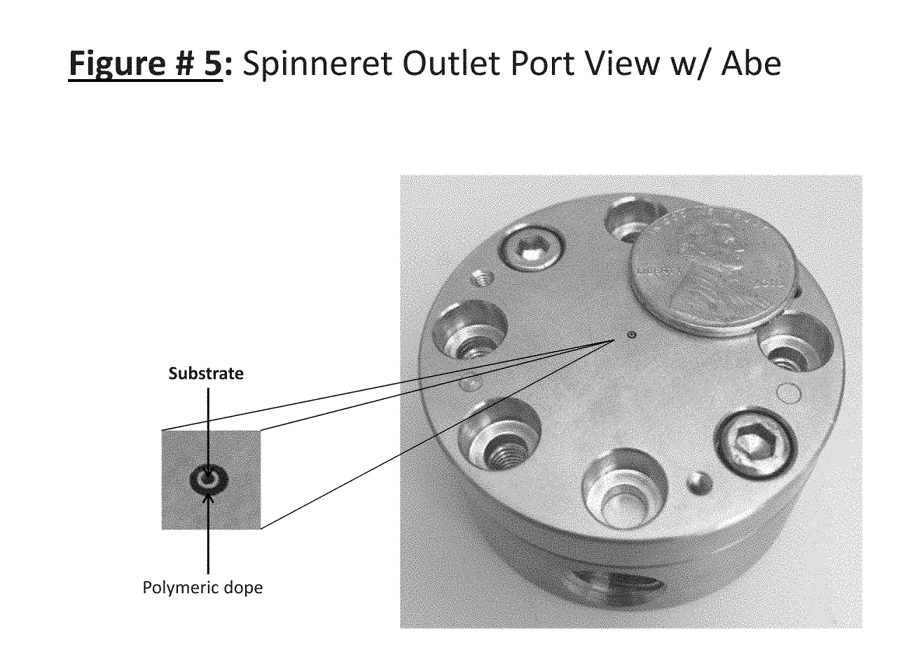

### DESCRIPTION OF PREFERRED EMBODIMENTS

A spinneret is proposed that allows for a separate solid fiber support (or a separate polymeric dope to be extruded therefrom) to be provided with an extruded coating of a separate polymeric dope comprised of adsorbent particles and a polymeric binder dissolved in a solvent.

As shown in the FIGS, the solid fiber support is fed from a spool to an aperture that extends through the spinneret. An annulus surrounding the aperture is fed with the polymeric dope (comprised of adsorbent particles suspended in polymeric binder dissolved in a solvent) and extruded therefrom so as to coat the solid fiber support ejected from the aperture of the spinneret and envelope the solid fiber support with the polymeric dope. The annulus is fed with the polymeric dope typically using a pump such as a conventional worm drive, gear pump or extruder so as to mix, degas and supply the polymeric dope in a single process to the annulus surrounding the aperture from which the solid fiber support is ejected.

The spinneret is designed to minimize back flow toward the spool while incorporating an annulus having a thickness sufficient to overcoat the solid fiber support. The spinneret and process so far has been defined as a single unit, one substrate, one coating and one filament, but may be processed with multiple devices and harnessed into a single housing of any desired configuration (e.g., linear, circular, etc.). This arrangement may then be overwrapped with a material to constrain or bundle multiple solid adsorbent fibers together, and further reduce individual filament tension into a bulk tension and allowing for a more rigorous product entering the forming stage. The housing apparatus constraining these devices may also be used as a heat exchanger to control viscosity of coating material or for specific properties associated with solvent evaporation. The aperture receiving the internal substrate may also include a supported bracket containing one or more eyelets and used as a guide to direct the substrate at a perpendicular angle and into the top orifice of mounted coating device. This will minimize friction and abrasion of the support substrate upon entry of this device.

The support may optionally be pre coated with an adhesion promoter, solvent/non solvent or a mix thereof, prior to entering the device. The solid support fiber is comprised of one or more organic materials, one or more inorganic materials, or combinations thereof. Typically, the solid support fiber is comprised of one or more metallic materials or one or more thermoplastic polymers. Suitable thermoplastic polymers for use in the solid support fiber include but are not limited to the heat-resistant polymeric binders disclosed in WO 2018/126194.

The types of polymeric binder and solvent suitable for use in the invention are not limited. Typically, the polymeric binder is any type of polymer which may be dissolved in a solvent and subsequently undergo phase inversion through coagulation in a coagulation so as to solidify it. The coagulation bath typically includes water and optionally a solvent that differs from the solvent of the polymeric dope. Particularly suitable types of polymeric binder are disclosed in WO 2018/126194.

Suitable solvents for the polymeric dope include those in which at least 98 wt % of the polymeric binder(s) dissolve. Depending on the polymeric binder(s) chosen and without limiting the scope of the invention, particular solvents include non-polar solvents, polar protic solvents as well as polar aprotic solvents. The latter include N-methyl-2-pyrrolidone (NMP), N,N-Dimethylformamide (DMF), N,N-Dimethylacetamide (DMAc), and N,N-Dimethylsulfoxide (DMSO), and combinations thereof. The solvent may also include an amount of a non-solvent (i.e., one that does not dissolve the polymeric binder(s)), but which is miscible with the solvent, in order to produce a single phase that is close to binodal. The composition of the polymeric binder(s) and solvent is hereinafter referred to as a polymer dope suspension.

The polymeric dope may include one or more salts added to the solvent(s) in order to facilitate the polymer dissolution, such as CaCl₂ or LiCl. The combination of solvent(s) and salt(s) should also be selected with the nature of the adsorbent used. For example, it may be desirable to include no salt with certain zeolites in order to prevent any ion exchange processes that would ultimately denature or transform the zeolite. On the other hand, salt(s) may be added so as to intentionally transform the zeolite by ionic exchange while in the adsorbent dope (made up of the polymeric binder(s), solvent(s), optional salts, adsorbent, and optional filler). Alternatively, no salt may be intentionally added to the dope suspension but the coagulated fiber may be subjected to further processing after formation, such as ion exchange in order to obtain the targeted adsorption properties. Such ion exchange processes are well known and maybe applied to the formed fiber without significant modification due to the chemical inertness of the utilized polymer.

The polymeric dope may include one or more organic and/or one or more inorganic fillers. For example, the adsorbent dope may include a filler comprising dry-spun fibrils made of a thermoplastic polymer. Fibrils made by dry-spinning inherently exhibit a high degree of crystallinity. Through inclusion of such high crystallinity fibrils, the flexibility of the inventive fiber may be improved. One type of inorganic filler includes relatively short carbon fiber, such as 5-20 μm long, in amounts up to 20 wt % so as to increase the mechanical properties of the sorbent extrudates. An alternative filler is fiberglass. The organic fillers may be a polymer that is soluble or insoluble in the solvent of the polymeric dope. The insoluble polymeric filler includes but is not limited to dry-spun fibrils made of a thermoplastic polymer. Examples of insoluble polymeric filler include poly(para-aramid) pulp or fibrils, (such as fiber made of Kevlar type 953 at a length of 500-1,000 μm). Inclusion of an insoluble poly(para-aramid) to a dissolved poly(meta-aramid) may allow the poly(para-aramid) to swell and thereby help to lock/entangle the poly(meta-aramid) and poly(para-aramid) polymers chains within one another while improving the mechanical properties of the sorbent extrudates. In order to enhance compatibility of blending insoluble polymeric fillers with the polymer binder of the polymer dope, the insoluble polymeric filler typically belongs to the same general class of polymers as the dissolved thermoplastic polymer in the polymeric dope. The insoluble polymeric filler may be identical to the polymeric binder of the polymeric dope but have a higher molecular weight than that of the soluble thermoplastic polymer or have a higher degree of crystallinity than that of the soluble thermplastic polymer. For example, a high degree of crystallinity may be achieved with rigid-chain polymers such as in MPD-I fiber produced by dry spinning.

Typically, the adsorbent has a particle size of less than or equal to 100 μm, typically less than or equal to 10 μm, and sometimes even less than or equal to 1 μm. It may be milled in order to achieve the desired size distribution. The type of adsorbent useable in the invention is not limited. Typically, it is any type of adsorbent known in the field of adsorption-based gas separation.

The polymeric dope may optionally be degassed under heat and/or vacuum prior to extrusion through a die or spinneret. The polymeric binder loading in the polymeric dope and the amount of solvent are carefully controlled in order to produce a single phase that is close to binodal. That way, as the ejected polymeric dope coating exits the spinneret and traverses through an optional air gap, solvent evaporating from the core spin dope composition either causes the exterior of the dope solution to solidify or brings it closer to solidification.

After extrusion of the solid support fiber and polymeric dope, it is plunged into one or more coagulation baths containing a coagulant medium where the polymeric dope undergoes phase inversion and thus solidification of the polymer matrix of the polymeric dope coating upon the solid support fiber. In selecting an appropriate coagulant medium composition and temperature, the nature of the adsorbent dope may be considered. After coagulation, the resulting adsorbent/polymer matrix can be best described as an opened-cell structure. Specifically, the polymer matrix encapsulates the adsorbent particulates in an opened-cell structure or cage structure, without sticking to the adsorbent particles so as to promote good mass transport.

The thus-formed solid adsorbent fiber may be collected on a take-up apparatus incorporated in the quenching medium, or independent from the quench medium, or just dispensed into a secondary container that may be designed for further washing or post conditioning.

The take up apparatus may include, a drum, rotational device also referred to as a skeining machine, a mandrel. or a mandrel incorporated with a traverse to control and apply the fiber to the apparatus in a desired pattern as a finished product or collected for another process.

In the case of adsorption-based fluid separations, the fiber may be formed as a discrete adsorbent bed. The adsorbent bed may be a stationary one or a mobile one (such as in On Board Oxygen Generation Systems or OBOGS). The adsorption-based fluid separation process may use the adsorbent bed as a non-fluidized bed, as a fluidized bed, or as a circulating bed. The adsorption process may be pressure swing adsorption (PSA), pressure-temperature swing adsorption (PTSA), temperature swing adsorption (TSA), vacuum swing adsorption (VSA), vacuum-pressure swing adsorption (VPSA), electro swing adsorption (ESA), rapid cycle pressure swing adsorption (RCPSA), or rapid cycle temperature swing adsorption (RCTSA). In a PSA process, particular non-limiting examples of a gas separation process performed using the adsorbent bed include purification of H2 (particularly for obtaining H2 from syngas or a syngas process gas such as one primarily containing H2, CO, N2, and CH4), for N2 capture from air, for CO2 removal from N2, and CO2 removal from CH4. In a TSA process, particular non-limiting examples of gas separation processes performed using the adsorbent bed includes de-humidification of air and de-carbonation of air such as in an air separation unit (such as in the front end purification unit of a cryogenic distillation-based ASU). The adsorbent bed may also be used in a VSA or VPSA process for capture of N2 capture from air to produce O2. One particular separation process is the front end purification (FEP) process for purification of air for feeding to a cryogenic distillation-based air separation unit (ASU) where amounts of CO2, H2O, and volatile organic compounds (VOCs) are removed from air to produce a feed for the ASU. The adsorbent bed may also be used for separation of liquids, such as condensed gases. Also, the adsorbent may be used for separation of vapors.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A method of manufacturing supported solid adsorbent fibers, comprising the steps of:
providing a spinneret that includes an aperture and an annulus surrounding at least a portion of the aperture at a downstream face of the spinneret, said aperture extending through the spinneret and being adapted and configured to receive a solid fiber support and pass the received solid fiber support from the aperture at said downstream face;
simultaneously feeding the solid fiber support through the aperture and feeding the polymeric dope suspension to the aperture;
simultaneously passing the solid fiber support through the aperture while extruding a polymeric dope suspension from the annulus so as to completely envelope the solid fiber, the polymeric dope suspension comprising adsorbent particles and a polymeric binder dissolved in a solvent; and
coagulating the polymeric dope suspension of the polymeric dope suspension-enveloped solid fiber support in a coagulation bath wherein amounts of the solvent are removed from the extruded polymeric dope suspension and the dissolved polymeric binder enveloping the solid support fiber is solidified so as to provide supported solid adsorbent fibers.

2. The method of claim 1, further comprising a step of degassing the polymeric dope suspension prior to said extrusion.

3. The method of claim 1, further comprising the step of extracting amounts of solvent remaining in the supported solid adsorbent fibers still present after said coagulation.

4. The method of claim 1, wherein the solid fiber support is produced by wet spinning or dry spinning;

5. The method of claim 1, further comprising the step of coating the solid fiber support with a functional layer either prior to or during said extursion, the functional layer comprising a selective layer or protective layer.

6. The method of claim 1, wherein the particles of adsorbent are a zeolite, that optionally undergoes ionic exchange in the polymeric dope suspension.

7. The method of claim 1, further comprising the step of coating the solid fiber support with an adhesion promoter layer, wherein the solid fiber support is comprised of a metal.

8. The method of claim 1, further comprising the step of functionalizing a surface of the solid fiber support by one of plasma treatment and chemical exposure so as to roughen a surface of the solid fiber support.

9. The method of claim 1, further comprising the step of heating the solid adsorbent fiber to a temperature at or above an activation temperature of thee particulate adsorbent.

10. The method of claim 9, further comprising the step of exposing the solid adsorbent fiber to a cross-linker agent prior to the activation step.

11. The method of claim 9, wherein the polymer binder comprises a polymer having a glass transition temperature and the solid adsorbent fiber is heated to a temperature below the glass transition temperature.

12. The method of claim 9, wherein the polymer binder comprises a polymer having a glass transition temperature and the solid adsorbent fiber is heated to a temperature at or above the glass transition temperature.

13. A method of manufacturing supported solid adsorbent fibers, comprising the steps of:
providing a spinneret that includes an aperture and a first annulus surrounding at least a portion of the aperture at a downstream face of the spinneret;
simultaneously feeding the aperture with a first polymeric dope and the first annulus with a second polymeric dope, the first polymeric dope comprising a first polymeric binder dissolved in a first solvent, the second polymeric dope comprising adsorbent particles and a second polymeric binder dissolved in a second solvent;
simultaneously extruding the first polymeric dope through the aperture and extruding the second polymeric dope suspension from the first annulus so as to completely envelope the extruded first polymeric dope with the extruded second polymeric dope and form a nascent solid supported fiber; and
coagulating the first and second polymeric dopes in a coagulation bath wherein amounts of the first and second solvents are removed from the extruded first and second polymeric dopes and the first and second polymeric binders are solidified so as to provide the supported solid adsorbent fibers.

14. The method of claim 13, further comprising the step of extruding a third polymeric dope from a second annulus concentrically disposed in between the aperture and the first aperture, wherein the third polymeric dope comprises a third polymeric binder dissolved in a third solvent and said coagulation step also removes amounts of said third solvent so as to solidify said third polymeric binder and form a functional layer in between the first solidified polymeric binder and the second solidified polymeric binder, the functional layer being a selective layer or a protective layer.
